(19) United States
(12) Patent Application Publication
(10) Pub. No.: US 2011/0317656 A1
(43) Pub. Date: Dec. 29, 2011

(54) CLUSTER-SPECIFIC REFERENCE SIGNALS FOR COMMUNICATION SYSTEMS WITH MULTIPLE TRANSMISSION POINTS

(75) Inventors: Myriam Rajih, Nuremberg (DE); Stefan Brueck, Neunkirchen am Brand (DE); Armin Dekorsy, Bremen (DE)

(73) Assignee: QUALCOMM Incorporated, San Diego, CA (US)

(21) Appl. No.: 12/974,281

(22) Filed: Dec. 21, 2010

Related U.S. Application Data
(60) Provisional application No. 61/289,885, filed on Dec. 23, 2009.

(51) Int. Cl. H04W 72/04

(52) U.S. Cl. 370/330

(57) ABSTRACT

Aspects of the present disclosure provide methods and apparatuses for transmitting—from all cells belonging to a cluster (e.g., for Joint Processing/Transmission (JP/T) Coordinated Multipoint (CoMP), also referred to as network MIMO (Multiple Input/Multiple Output))—reference signals (RSs) for channel state information (CSI) feedback to user equipment (UE) at the same time and frequency resources. In this manner, data is precluded from interfering with the CSI feedback scheme. Consequently, data need not be determined to reliably estimate the channel(s).

### CROSS-REFERENCE TO RELATED APPLICATION(S)

This application claims the benefit of U.S. Provisional Patent Application No. 61/289,885 entitled “Cluster Specific Channel State Information Reference Signals for OFDM Based Communication Systems Applying Multiple Transmission Points,” filed on Dec. 23, 2009, the disclosure of which is expressly incorporated by reference herein in its entirety.

### BACKGROUND

1. Field

Certain aspects of the present disclosure generally relate to wireless communications and, more particularly, to generating reference signals for wireless communication systems using multiple transmission entities to communicate with a single user equipment (UE) device.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication with a number of user equipment (UE) devices. A UE may communicate with a base station via the downlink and uplink. The downlink (or forward link) refers to the communication link from the base station to the UE, and the uplink (or reverse link) refers to the communication link from the UE to the base station. A base station may transmit data and control information on the downlink to a UE and/or may receive data and control information on the uplink from the UE.

### SUMMARY

Certain aspects of the present disclosure generally relate to all cells belonging to a cluster (e.g., for Joint Processing/Transmission (JP/T) Coordinated Multipoint (CoMP), also referred to as network MIMO (Multiple Input/Multiple Output)) transmitting reference signals (RSs) for channel state information (CSI) feedback to a particular user equipment (UE) at the same time and frequency resources, thereby avoiding interference with the CSI feedback scheme from data.

Certain aspects of the present disclosure provide a method for wireless communications. The method generally includes determining, by a cell in a cluster of cells, one or more common time-frequency resources for use by cells in the cluster to transmit a reference signal, wherein the cells in the cluster cooperate to transmit data to a set of user equipment (UE) devices; and transmitting, from the cell, the reference signal at the common time-frequency resources.

Certain aspects of the present disclosure provide an apparatus for wireless communications. The apparatus generally includes a processing system configured to determine, by the apparatus in a cluster of apparatuses, one or more common time-frequency resources for use by apparatuses in the cluster to transmit a reference signal, wherein the apparatuses in the cluster cooperate to transmit data to a set of user equipment (UE) devices; and a transmitter configured to transmit the reference signal at the common time-frequency resources.

Certain aspects of the present disclosure provide an apparatus for wireless communications. The apparatus generally includes means for determining, by the apparatus in a cluster of apparatuses, one or more common time-frequency resources for use by apparatuses in the cluster to transmit a reference signal, wherein the apparatuses in the cluster cooperate to transmit data to a set of UE devices; and means for transmitting the reference signal at the common time-frequency resources.

Certain aspects of the present disclosure provide a computer-program product for wireless communications. The computer-program product generally includes a computer-readable medium having instructions executable to determine, by a cell in a cluster of cells, one or more common time-frequency resources for use by cells in the cluster to transmit a reference signal, wherein the cells in the cluster cooperate to transmit data to a set of UE devices; and to transmit, from the cell, the reference signal at the common time-frequency resources.

Certain aspects of the present disclosure provide a method for wireless communications. The method generally includes receiving, at a UE, a reference signal transmitted from each of a plurality of cells in a cluster at one or more common time-frequency resources, wherein the cells in the cluster cooperate to transmit data to a set of UE devices including the UE; determining channel state information (CSI) based on the reference signal; and transmitting the CSI to the cells in the cluster.

Certain aspects of the present disclosure provide an apparatus for wireless communications. The apparatus generally includes a receiver configured to receive a reference signal transmitted from each of a plurality of cells in a cluster at one or more common time-frequency resources, wherein the cells in the cluster cooperate to transmit data to a set of UE devices including the apparatus; a processing system configured to determine CSI based on the reference signal; and a transmitter configured to transmit the CSI to the cells in the cluster.

Certain aspects of the present disclosure provide an apparatus for wireless communications. The apparatus generally includes means for receiving a reference signal transmitted from each of a plurality of cells in a cluster at one or more common time-frequency resources, wherein the cells in the cluster cooperate to transmit data to a set of UE devices including the apparatus; means for determining CSI based on the reference signal; and means for transmitting the CSI to the cells in the cluster.

Certain aspects of the present disclosure provide a computer-program product for wireless communications. The computer-program product generally includes a computer-readable medium having instructions executable to receive, at a UE, a reference signal transmitted from each of a plurality of cells in a cluster at one or more common time-frequency resources, wherein the cells in the cluster cooperate to transmit data to a set of UE devices including the UE; to determine CSI based on the reference signal; and to transmit the CSI to the cells in the cluster.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communication system in accordance with certain aspects of the present disclosure.

FIG. 2 illustrates a block diagram of an eNode B (eNB) and user equipment (UE) in accordance with certain aspects of the present disclosure.

FIG. 3 illustrates a block diagram of a master cell and a slave cell transmitting a cluster-specific reference signal (RS) to a UE in accordance with certain aspects of the present disclosure.

FIG. 4 illustrates cell-specific reference signals (CRSs) for two cells with different cell identifiers (IDs) in accordance with certain aspects of the present disclosure.

FIG. 5 illustrates an example of cluster-specific channel state information reference signals (CSI-RSs) in accordance with certain aspects of the present disclosure.

FIG. 6 illustrates example operations that may be performed at a cell belonging to a cluster of cells for transmitting a cluster-specific CSI-RS using time-frequency resources common among the cells in the cluster, in accordance with certain aspects of the present disclosure.

FIG. 6A illustrates example means capable of performing the operations illustrated in FIG. 6.

FIG. 7 illustrates example operations that may be executed at a UE for determining CSI based on a received cluster-specific CSI-RS transmitted using time-frequency resources common among cells belonging to a cluster of cells, in accordance with certain aspects of the present disclosure.

FIG. 7A illustrates example means capable of performing the operations illustrated in FIG. 7.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

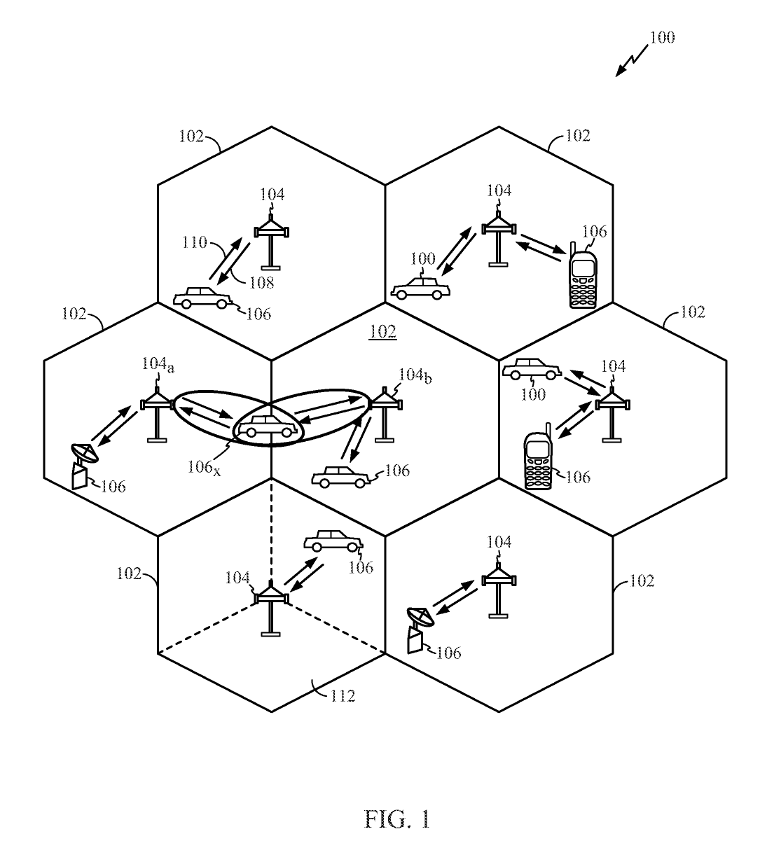

FIG. 1 shows a wireless communication network 100, which may be an LTE network. Wireless network 100 may include a number of evolved Node Bs (eNBs) 104 and other network entities. An eNB may be a station that communicates with the UEs, and may also be referred to as a base station, a Node B, an access point, etc. Each eNB 104 may provide communication coverage for a particular geographic area. In 3GPP, the term “cell” can refer to a coverage area of an eNB and/or an eNB subsystem serving this coverage area, depending on the context in which the term is used.

A network controller (not shown) may couple to a set of eNBs and provide coordination and control for these eNBs. The network controller may communicate with eNBs 104 via a backhaul. eNBs 104 may also communicate with one another, e.g., directly or indirectly via wireless or wireline backhaul using X2, for example.

UEs 106 may be dispersed throughout wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. In some aspects the UE is a wireless node. Such a wireless node may provide, for example, connectivity for or to a network (e.g., a wide area network such as the Internet or a cellular network) via a wired or wireless communication link. In FIG. 1, a solid line with double arrows indicates desired transmissions between a UE and a serving eNB, which is an eNB designated to serve the UE on the downlink (DL) 108 and/or uplink (UL) 110.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

Each group of antennas and/or the area in which the antenna group is designed to communicate is often referred to as a sector 112 of the eNB. For certain aspects, each antenna group may be designed to communicate to access terminals in a sector 112 of the cell 102 covered by an eNB 104.

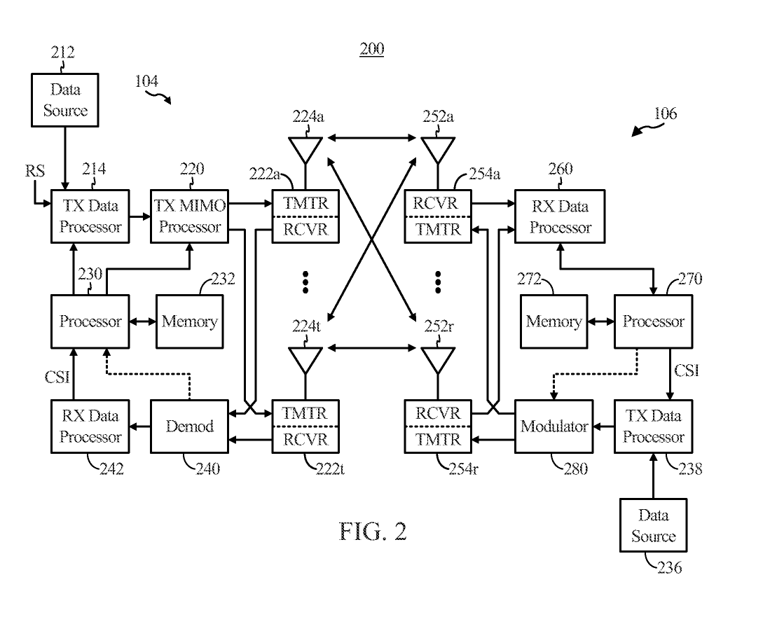

FIG. 2 is a block diagram showing an exemplary eNB 104 (also known as a access point or base station) and an exemplary UE 106 (also known as a mobile station or an access terminal) in a multiple-input multiple-output (MIMO) system 200. The eNB 104 may be equipped with T antennas 224a through 224t, and the UE 106 may be equipped with R antennas 252a through 252r, where in general T≧1 and R≧1.

At the eNB 104, a transmit (TX) data processor 214 may receive data from a data source 212 to and control information from a controller/processor 230. The TX data processor 214 may process (e.g., encode and symbol map) the data and control information to obtain data symbols and control symbols, respectively. The TX data processor 214 may also receive a reference signal (RS), which may be generated by the controller/processor 230 for certain aspects. For other aspects, the TX data processor 214 may generate the RS.

In one aspect of the present disclosure, each data stream may be transmitted over a respective transmit antenna. The TX data processor 214 formats, codes, and interleaves the traffic data for each data stream based on a particular coding scheme selected for that data stream to provide coded data.

The coded data for each data stream may be multiplexed with the RS using OFDM techniques. The RS is typically a known data pattern that is processed in a known manner and may be used at the UE 106 to estimate the channel response. The multiplexed RS and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by the controller/processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects of the present disclosure, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At the UE 106, the transmitted modulated signals may be received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and further process the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data (and, for certain aspects, the RS) for the data stream and provides decoded control information to a controller/processor 270. The processing by RX data processor 260 may be complementary to that performed by TX MIMO processor 220 and TX data processor 214 at the eNB 104. The controller/processor 270 may determine the CSI as shown in FIG. 2.

The reverse link message may comprise various types of information regarding the communication link (e.g., the CSI) and/or the received data stream. The reverse link message is then processed by a TX data processor 238, which also receives traffic data for a number of data streams from a data source 236 in addition to the CSI from the controller/processor 270, modulated by a modulator 280, conditioned by transmitters 254a through 254r, and transmitted back to the eNB 104.

At the eNB 104, the modulated signals from the UE 106 are received by antennas 224, conditioned by receivers 222, demodulated by a demodulator 240, and processed by a RX data processor 242 to extract the reverse link message (including, e.g., the CSI) transmitted by the UE 106.

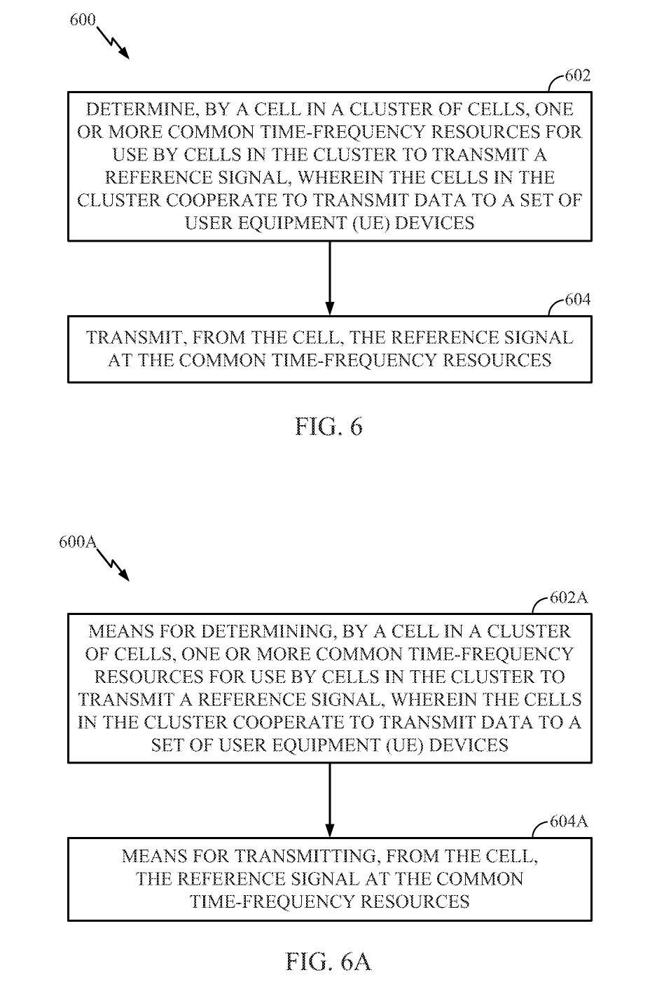

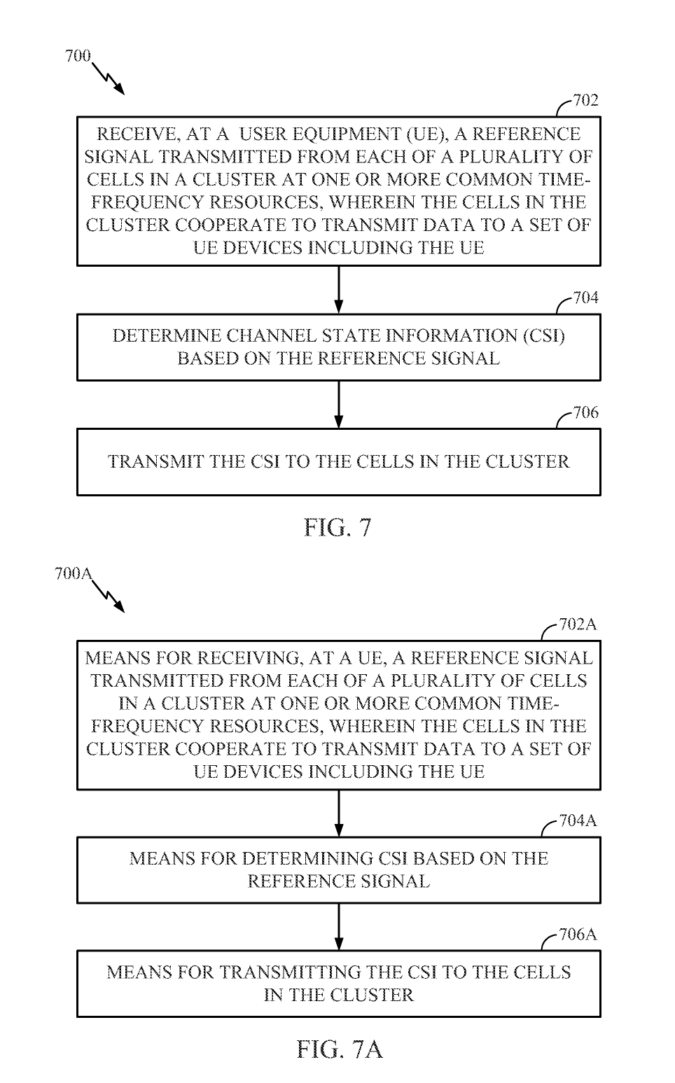

As described above, controllers/processors 230 and 270 may direct the operations at the eNB 104 and UE 106, respectively. Controller/processor 230, the TX data processor 214, and/or other processors and modules at the eNB 104 may perform or direct at least some of the operations 600 in FIG. 6 and/or other processes for the techniques described herein. Controller/processor 270, the RX data processor 260, and/or other processors and modules at the UE 106 may perform or direct at least some of the operations 700 in FIG. 7 and/or other processes for the techniques described herein. Memories 232 and 272 may store data and program codes for eNB 104 and UE 106, respectively. A scheduler (not shown) may schedule UEs for data transmission on the downlink and/or uplink.

### Example Cluster-Specific CSI Reference Signals

The Long Term Evolution Advanced (LTE-A) standard (also known as the LTE Release 10 (Rel-10) standard) specifies Orthogonal Frequency Division Multiplexing (OFDM) technology and adaptive modulation and coding schemes (MCSs) in downlink transmission. In order to allow adapting the MCS to instantaneous channel conditions, channel state information (CSI) may be fed back to a transmission point (i.e., to an eNB 104). To generate the CSI feedback, estimation of the channel quality across the entire bandwidth may be performed. Typically, cell-specific reference signals (CRSs) may be employed for the CSI feedback, which is the case in the LTE Release 8 specification, where locations of the CRS in the time and frequency domains depend only on a cell identifier (ID).

In LTE Release 8 (Rel-8), each UE 106 is connected to one eNB 104 only, so there is one downlink transmission point per UE. LTE-Advanced may allow sending data from multiple transmission points to a single UE (e.g., joint processing/transmission cooperative multipoint (JP/T CoMP) schemes). Multiple transmission points may refer not only to cooperating cells of different sites, but also to different cells of the same site. A set of cooperating cells that transmit data to a set of UEs may be denoted as a cluster of cells.

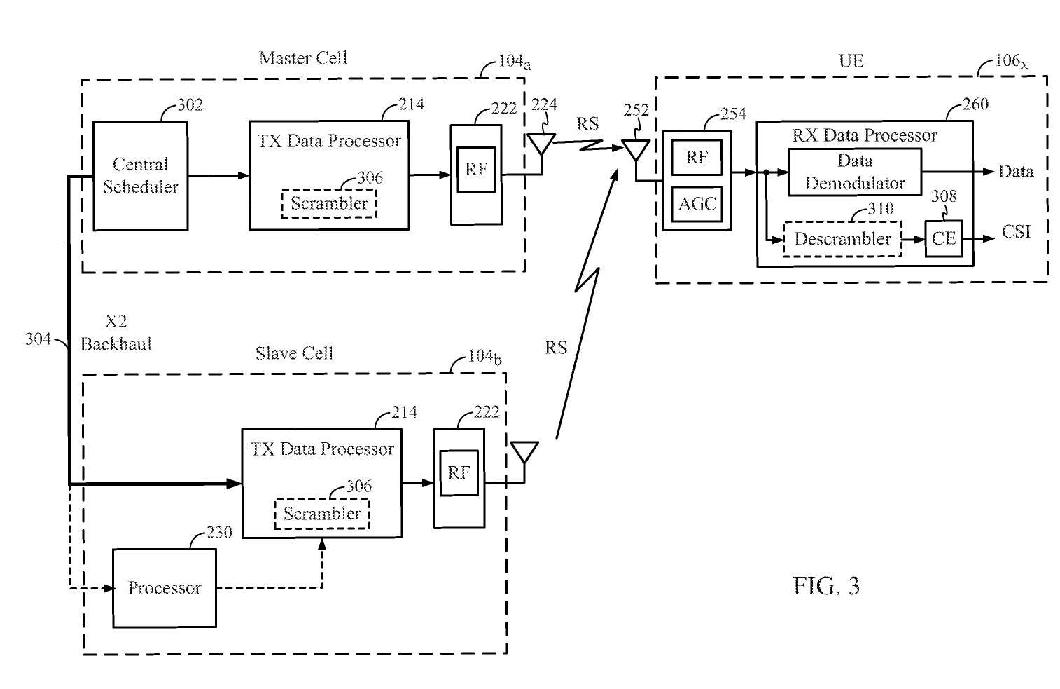

FIG. 3 illustrates a block diagram of a JP/T CoMP scheme where two transmission points (here, eNB 104ₐ and eNB 104_{b}) in a cluster cooperate to send the same data to a single UE 106ₓ. This JP/T CoMP scheme is also illustrated in FIG. 1, wherein at least two of the seven cells shown are part of the same cluster. One of the transmission points in the cluster may be referred to as the master cell 104ₐ (or master sector, primary cell, anchor cell, etc.), while the other transmission points may be considered as slave cells 104_{b} (or slave sectors, cooperating cells, coordinated cells, etc.). A central scheduler 302 in the master cell may manage the resources of the cluster. The master cell 104ₐ may distribute scheduling information to the slave cells over a backhaul 304, which may utilize an X2 interface.

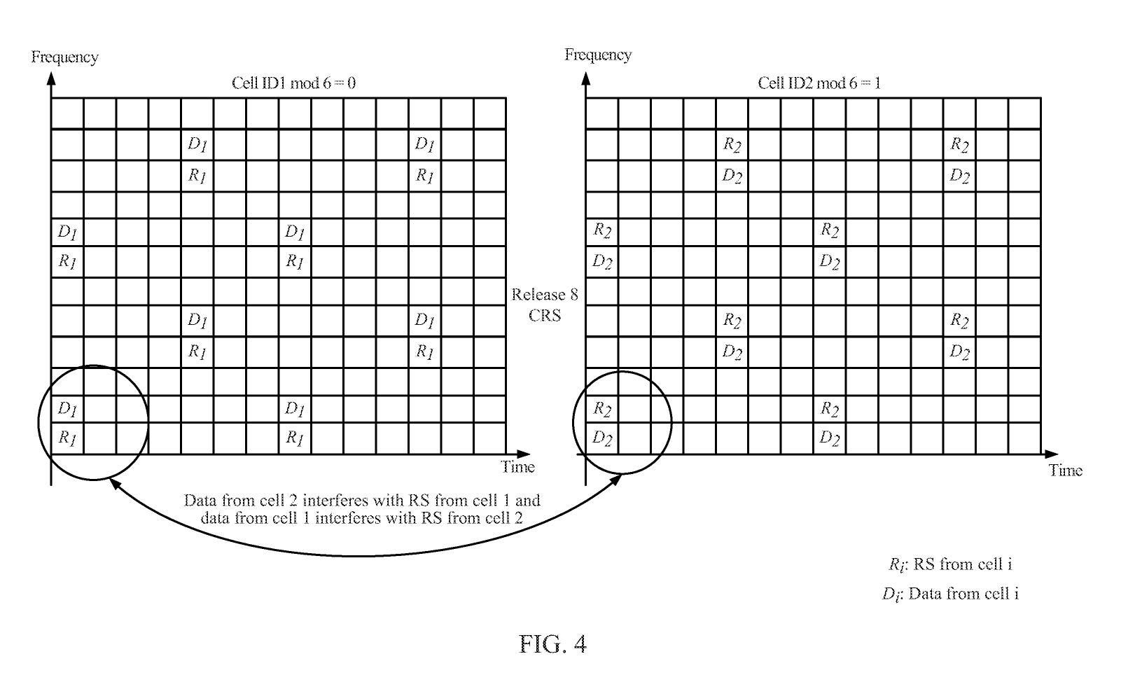

For such transmission schemes with cooperating transmission points, a single UE may estimate and feed back CSI for multiple radio channels. However, the transmission of cell-specific reference signals (CRSs) specified by the LTE Release 8 standard is not suitable for JP/T CoMP transmission. If the CRS specified by LTE Release 8 is applied for CSI feedback in the JP/T CoMP mode, then the CRS of one transmission link may be subject to interference caused by data transmission on the other links and vice versa, as illustrated in FIG. 4. In FIG. 4, data from cell 2 (D₂) interferes with the CRS from cell 1 (R₁), and data from cell 1 (D₁) interferes with the CRS from cell 2 (R₂). This is because time-frequency locations of the CRS are determined based on the cell identifiers (IDs) and, therefore, differ from one cell to another. This does not allow estimating multiple channels reliably without estimating the data symbols, as well.

Accordingly, the present disclosure provides a more efficient CSI feedback for JP/T CoMP schemes than the cell-specific reference signal (CRS) structure specified by the LTE Release 8 standard.

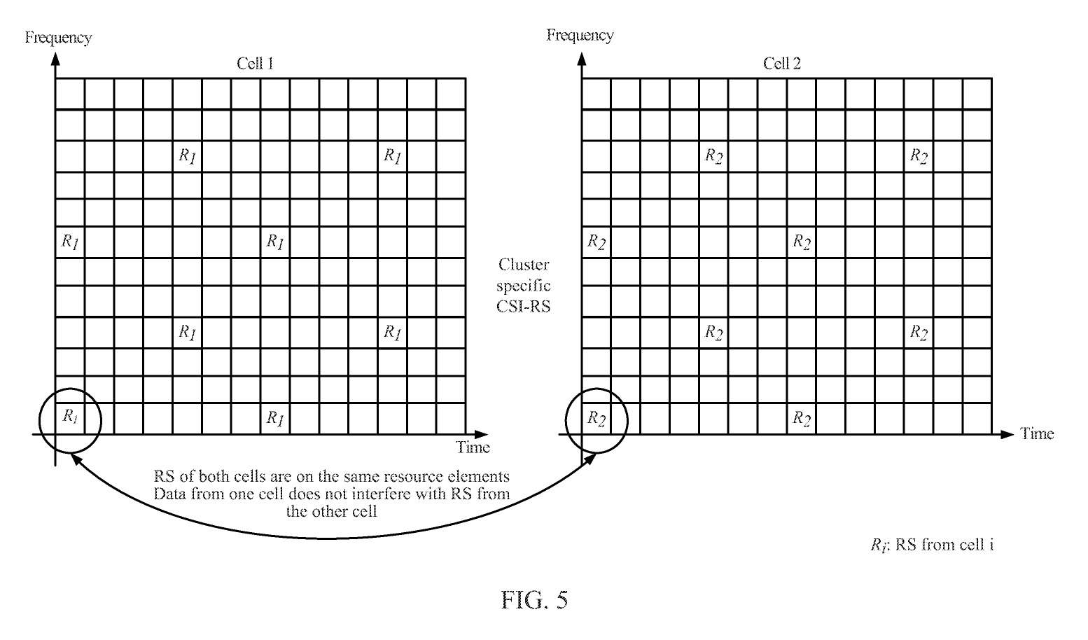

In contrast with the cell-specific reference signals of FIG. 4, FIG. 5 illustrates an example of cluster-specific channel state information (CSI) reference signals (CSI-RSs) in accordance with certain aspects of the present disclosure. With cluster-specific reference signals, all cells belonging to a given cluster may transmit their reference signals for channel state information feedback (i.e., CSI-RS) at the same locations in the frequency and time domains as illustrated in FIG. 5, thereby avoiding data interfering with the CSI-RSs. The locations of the CSI-RSs within the cluster may no longer depend on the individual cell identifiers (IDs) of the cells belonging to the cluster. Instead, certain aspects of the present disclosure may determine the locations of the CSI-RS according to a cluster identifier (ID) or any other criterion that uniquely addresses the cluster. In this manner, the CSI-RS disclosed herein may be cluster specific rather than cell specific.

The term “cluster-specific CSI-RS” implies that different clusters may apply different CSI-RSs. In other words, the cluster-specific CSI-RS of different clusters may be transmitted at different locations in frequency and/or time. If different clusters apply the same cluster specific CSI-RSs (e.g., due to limitations in specifying different cluster IDs), these clusters may preferably be separated by a sufficient geographical distance in an effort to avoid interference between the clusters.

Two types of cluster-specific CSI-RSs may be used: (1) an identical cluster specific CSI-RS and (2) a non-identical cluster specific CSI-RS. In the case of identical cluster-specific CSI-RSs, transmitted symbols of the RS at a fixed time-frequency location may be identical for all cells belonging to a particular cluster. The identical cluster-specific CSI-RSs may allow a UE 106 to directly estimate, over the air (OTA), the combined channel between all transmission points and the UE.

In the case of non-identical cluster-specific CSI-RSs, the CSI-RSs transmitted from different cells of the cluster may be (pseudo-)orthogonal. A cluster-specific scrambling code may be applied to the cluster-specific CSI-RS before transmission over the air in order to achieve (pseudo-)orthogonality over an averaging period in frequency and/or time. The non-identical cluster specific CSI-RSs may allow the application of joint channel estimation or RS interference cancellation.

Furthermore, the cluster-specific CSI-RS may be reconfigured once the cluster changes (i.e., membership in the cluster changes) over time. If new cells are added to the cluster, then these new cells may apply the cluster specific CSI-RS as well.

FIG. 6 illustrates example operations 600 that may be performed at a cell (e.g., an eNB 104) belonging to a cluster of cells for transmitting cluster-specific CSI-RS using time-frequency resources common among the cells in the cluster. At 602, the cell in the cluster may determine one or more common time-frequency resources (e.g., resource elements (REs)) for use by cells in the cluster to transmit a reference signal. Cells in the cluster may cooperate to transmit data to a set of UE devices. At 604, a reference signal (e.g., the cluster-specific CSI-RS) may be transmitted from the cell at the common time-frequency resources.

For certain aspects, the cells in the cluster may apply a cell-specific scrambling code to the reference signal before transmitting the reference signal. Such application of a scrambling code may be applied to the reference signal by a scrambler 306. The scrambler 306 may be part of the TX data processor 214 (as depicted in FIG. 3) or another suitable processor, or the scrambler may be a dedicated processor separate from any of the processors shown in FIG. 2.

For certain aspects, the cell (e.g, eNB 104_{b}) may receive an indication of the time-frequency resources to use to transmit the reference signal from another cell (e.g., the master cell 104ₐ) in the cluster having a scheduler (e.g., central scheduler 302) for managing the time-frequency resources of the cluster. This indication of the time-frequency resources may be received via the backhaul 304 between the cells in the cluster. For certain aspects, the controller/processor 230 and/or the TX data processor 214 may receive the indication of the time-frequency resources.

For other aspects, the cell in the cluster may select the time-frequency resources for all the cells in the cluster and may transmit an indication of the time-frequency resources to the other cells in the cluster. In other words, the cell may be the master cell 104ₐ and may comprise the scheduler (e.g., central scheduler 302) for managing time-frequency resources of the cluster. The indication of the time-frequency resources may be transmitted via the backhaul 304 between the cells in the cluster using the X2 interface, for example. For certain aspects, the central scheduler 302 or the controller/processor 230 may transmit the indication of the time-frequency resources.

FIG. 7 illustrates example operations 700 that may be executed at a UE, for example, for determining channel state information (CSI) based on a received cluster-specific CSI-RS transmitted using time-frequency resources common among cells belonging to a cluster of cells. At 702, the UE may receive a reference signal (e.g., the cluster-specific CSI-RS) transmitted from each of a plurality of cells in a cluster at one or more common time-frequency resources (e.g., REs). At 704, the UE may determine CSI based on the reference signal. At 706, the UE may transmit the CSI to the cells in the cluster.

For certain aspects, determining the CSI may comprise directly estimating channel quality of a combined channel, the combined channel comprising channels from the plurality of cells (e.g., a combination of the channels between eNBs 104ₐ, eNB 104_{b} and UE 106ₓ). For other aspects, determining the CSI may comprise independently estimating channel quality of each channel of a plurality of channels based on the reference signal, each channel comprising a link between a cell of the plurality of cells and the UE (e.g., separately estimating channel quality for a first link between eNB 104ₐ and UE 106ₓ, and a second link between eNB 104_{b} and UE 106ₓ). The channel quality estimation(s) may be performed by a channel estimator (CE) 308. The CE 308 may be part of the RX data processor 260 or the controller/processor 270, or the CE 308 may be a dedicated stand-alone processor.

For certain aspects, the UE may descramble the reference signal received from each of the plurality of cells before determining the CSI. The scrambling code applied to the reference signal transmitted from a cell in the cluster may be different than another scrambling code applied to another reference signal transmitted from another cell in the cluster. This descrambling may be performed by a descrambler 310. The descrambler 310 may be part of the RX data processor 260 or the controller/processor 270, or the descrambler 310 may be a dedicated stand-alone processor.

There are several advantages to transmitting a cluster-specific CSI-RS in common time-frequency locations. First, there may be no interference on the CSI-RS caused by data from other cells in the cluster. As a consequence, the data symbols need not be ascertained to reliably estimate the channel. Therefore, CSI feedback entities (e.g., CE 308) and data demodulation entities (e.g., data demodulator 312) may run independently from each other at the receiver side, which reduces the CSI feedback delays.

If identical cluster-specific CSI-RSs are applied at all transmission points, then the over-the-air (OTA) combined channel impulse responses may be estimated directly in case of non-coherent JP/T CoMP. This may reduce the losses for the CSI feedback since the CSI of the combined channel may be directly estimated. It should be noted that in this case, the data transmitted from the cooperating cells of the cluster may be the same.

In the case of non-identical cluster-specific CSI-RSs, the UE may be able to separately estimate each link between one transmission point and the UE allowing link-specific CSI feedback. RS interference cancellation or any other advanced receiver technology (e.g., joint detection) may be applied in case of coherent JP/T CoMP since data-to-RS interference may be avoided by cluster-specific reference signals.

Another approach to avoid the interference caused by data on the RS may be data nulling. With data nulling, data from one cell may not be transmitted on the RS resource elements of another cell. Compared to data nulling, the cluster-specific CSI-RS approach disclosed herein may not have any loss of peak data rate since all resource elements not being utilized for transmission of the RS may be available for data transmission. No non-RS resource elements are to be left idle for data transmission (as such elements are for data nulling) since data-to-RS interference may be avoided by the use of cluster-specific CSI-RS.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the Figures, those operations may have corresponding counterpart means-plus-function components with similar numbering. For example, operations 600 and 700 illustrated in FIGS. 6 and 7 correspond to components 600A and 700A illustrated in FIGS. 6A and 7A, respectively.

For example, the means for transmitting may comprise a transmitter, such as the transmitter unit 222 of the eNB 104 illustrated in FIG. 2 or the transmitter unit 254 of the UE 106 depicted in FIG. 2. The means for receiving may comprise a receiver, such as the receiver unit 222 of the eNB 104 illustrated in FIG. 2 or the receiver unit 254 of the UE 106 depicted in FIG. 2. The means for determining or means for processing may comprise a processing system, which may include one or more processors, such as the RX data processor 260 and/or the controller/processor 270 of the UE 106 or the TX data processor 214 and/or the controller/processor 230 of the eNB 104 illustrated in FIG. 2. The means for determining CSI may comprise any of the above means for processing and/or the CE 308. The means for scrambling may comprise any of the above means for processing and/or the scrambler 306, while the means for descrambling may comprise any of the means for processing and/or the descrambler 310. The means for scheduling may comprise any of the above means for processing and/or a scheduler, such as the central scheduler 302.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of an access terminal 110 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications, comprising:
determining, by a cell in a cluster of cells, one or more common time-frequency resources for use by cells in the cluster to transmit a reference signal, wherein the cells in the cluster cooperate to transmit data to a set of user equipment (UE) devices; and
transmitting, from the cell, the reference signal at the common time-frequency resources.

2. The method of claim 1, wherein the time-frequency resources are determined according to a cluster identifier (ID) identifying the cluster.

3. The method of claim 1, wherein symbols of the reference signal transmitted from the cell at the determined time-frequency resources are the same as symbols of another reference signal transmitted at the same time-frequency resources from another cell in the cluster.

4. The method of claim 1, further comprising applying a cell-specific scrambling code to the reference signal before transmitting the reference signal.

5. The method of claim 1, wherein determining the time-frequency resources comprises:
selecting, by the cell in the cluster, the time-frequency resources for the cells in the cluster, wherein the cell comprises a scheduler for managing the time-frequency resources of the cluster; and
transmitting an indication of the time-frequency resources to cells in the cluster other than the cell with the scheduler.

6. The method of claim 1, wherein determining the time-frequency resources comprises receiving an indication of the time-frequency resources from another cell in the cluster having a scheduler for managing the time-frequency resources of the cluster.

7. The method of claim 1, further comprising receiving, from one of the UE devices, channel state information (CSI) based on the reference signal.

8. An apparatus for wireless communications, comprising:
a processing system configured to determine, by the apparatus in a cluster of apparatuses, one or more common time-frequency resources for use by apparatuses in the cluster to transmit a reference signal, wherein the apparatuses in the cluster cooperate to transmit data to a set of user equipment (UE) devices; and
a transmitter configured to transmit the reference signal at the common time-frequency resources.

9. The apparatus of claim 8, wherein the time-frequency resources are determined according to a cluster identifier (ID) identifying the cluster.

10. The apparatus of claim 8, wherein symbols of the reference signal transmitted from the apparatus at the common time-frequency resources are the same as symbols of another reference signal transmitted at the same time-frequency resources from another apparatus in the cluster.

11. The apparatus of claim 8, wherein the processing system is configured to apply an apparatus-specific scrambling code to the reference signal before transmitting the reference signal.

12. The apparatus of claim 8, wherein the processing system comprises a scheduler for managing the time-frequency resources of the cluster, wherein the processing system is configured to determine the time-frequency resources by selecting the time-frequency resources for the apparatuses in the cluster using the scheduler, and wherein the transmitter is configured to transmit an indication of the time-frequency resources to apparatuses in the cluster other than the apparatus with the scheduler.

13. The apparatus of claim 8, wherein the processing system is configured to determine the time-frequency resources by receiving an indication of the time-frequency resources from another apparatus in the cluster having a scheduler for managing the time-frequency resources of the cluster.

14. The apparatus of claim 8, further comprising a receiver configured to receive, from one of the UE devices, channel state information (CSI) based on the reference signal.

15. An apparatus for wireless communications, comprising:
means for determining, by the apparatus in a cluster of apparatuses, one or more common time-frequency resources for use by apparatuses in the cluster to transmit a reference signal, wherein the apparatuses in the cluster cooperate to transmit data to a set of user equipment (UE) devices; and
means for transmitting the reference signal at the common time-frequency resources.

16. The apparatus of claim 15, wherein the time-frequency resources are determined according to a cluster identifier (ID) identifying the cluster.

17. The apparatus of claim 15, wherein symbols of the reference signal transmitted from the apparatus at the determined time-frequency resources are the same as symbols of another reference signal transmitted at the same time-frequency resources from another apparatus in the cluster.

18. The apparatus of claim 15, further comprising means for applying an apparatus-specific scrambling code to the reference signal before transmitting the reference signal.

19. The apparatus of claim 15, wherein the means for determining the time-frequency resources comprises a means for scheduling the time-frequency resources of the cluster, wherein the means for determining the time-frequency resources is configured to select the time-frequency resources for the apparatuses in the cluster using the means for scheduling, and wherein the means for transmitting is configured to transmit an indication of the time-frequency resources to apparatuses in the cluster other than the apparatus with the means for scheduling.

20. The apparatus of claim 15, further comprising means for receiving an indication of the time-frequency resources from another cell in the cluster having a means for scheduling the time-frequency resources of the cluster, wherein the means for determining the time-frequency resources is configured to use the received indication of the time-frequency resources.

21. The apparatus of claim 15, further comprising means for receiving, from one of the UE devices, channel state information (CSI) based on the reference signal.

22. A computer-program product for wireless communications, comprising a computer-readable medium comprising instructions executable by a processor to:
determine, by a cell in a cluster of cells, one or more common time-frequency resources for use by cells in the cluster to transmit a reference signal, wherein the cells in the cluster cooperate to transmit data to a set of user equipment (UE) devices; and
transmit, from the cell, the reference signal at the common time-frequency resources.

23. The computer-program product of claim 22, wherein the time-frequency resources are determined according to a cluster identifier (ID) identifying the cluster.

24. The computer-program product of claim 22, wherein symbols of the reference signal transmitted from the cell at the determined time-frequency resources are the same as symbols of another reference signal transmitted at the same time-frequency resources from another cell in the cluster.

25. The computer-program product of claim 22, further comprising instructions executable by the processor to apply a cell-specific scrambling code to the reference signal before transmitting the reference signal.

26. A method for wireless communications, comprising:
receiving, at a user equipment (UE), a reference signal transmitted from each of a plurality of cells in a cluster at one or more common time-frequency resources, wherein the cells in the cluster cooperate to transmit data to a set of UE devices including the UE;
determining channel state information (CSI) based on the reference signal; and
transmitting the CSI to the cells in the cluster.

27. The method of claim 26, wherein the time-frequency resources are based on a cluster identifier (ID) identifying the cluster.

28. The method of claim 26, wherein determining the CSI comprises directly estimating channel quality of a combined channel, the combined channel comprising channels between the plurality of cells and the UE.

29. The method of claim 26, wherein determining the CSI comprises independently estimating channel quality of each channel of a plurality of channels based on the reference signal, each channel comprising a link between a cell of the plurality of cells and the UE.

30. The method of claim 26, further comprising descrambling the reference signal received from each of the plurality of cells before determining the CSI, wherein a scrambling code applied to the reference signal transmitted from a cell in the cluster is different than another scrambling code applied to another reference signal transmitted from another cell in the cluster.

31. The method of claim 30, wherein determining the CSI comprises independently estimating channel quality of each channel of a plurality of channels based on the descrambled reference signal, each channel comprising a link between a cell of the plurality of cells and the UE.

32. An apparatus for wireless communications, comprising:
a receiver configured to receive a reference signal transmitted from each of a plurality of cells in a cluster at one or more common time-frequency resources, wherein the cells in the cluster cooperate to transmit data to a set of user equipment (UE) devices including the apparatus;
a processing system configured to determine channel state information (CSI) based on the reference signal; and
a transmitter configured to transmit the CSI to the cells in the cluster.

33. The apparatus of claim 32, wherein the time-frequency resources are based on a cluster identifier (ID) identifying the cluster.

34. The apparatus of claim 32, wherein the processing system is configured to determine the CSI by directly estimating channel quality of a combined channel, the combined channel comprising channels between the plurality of cells and the apparatus.

35. The apparatus of claim 32, wherein the processing system is configured to determine the CSI by independently estimating channel quality of each channel of a plurality of channels based on the reference signal, each channel comprising a link between a cell of the plurality of cells and the apparatus.

36. The apparatus of claim 32, wherein the processing system is configured to descramble the reference signal received from each of the plurality of cells before determining the CSI, wherein a scrambling code applied to the reference signal transmitted from a cell in the cluster is different than another scrambling code applied to another reference signal transmitted from another cell in the cluster.

37. The apparatus of claim 36, wherein the processing system is configured to determine the CSI by independently estimating channel quality of each channel of a plurality of channels based on the descrambled reference signal, each channel comprising a link between a cell of the plurality of cells and the apparatus.

38. An apparatus for wireless communications, comprising:
means for receiving a reference signal transmitted from each of a plurality of cells in a cluster at one or more common time-frequency resources, wherein the cells in the cluster cooperate to transmit data to a set of user equipment (UE) devices including the apparatus;
means for determining channel state information (CSI) based on the reference signal; and
means for transmitting the CSI to the cells in the cluster.

39. The apparatus of claim 38, wherein the time-frequency resources are based on a cluster identifier (ID) identifying the cluster.

40. The apparatus of claim 38, wherein the means for determining the CSI is configured to directly estimate channel quality of a combined channel, the combined channel comprising channels between the plurality of cells and the apparatus.

41. The apparatus of claim 38, wherein the means for determining the CSI is configured to independently estimate channel quality of each channel of a plurality of channels based on the reference signal, each channel comprising a link between a cell of the plurality of cells and the apparatus.

42. The apparatus of claim 38, further comprising means for descrambling the reference signal received from each of the plurality of cells before determining the CSI, wherein a scrambling code applied to the reference signal transmitted from a cell in the cluster is different than another scrambling code applied to another reference signal transmitted from another cell in the cluster.

43. The apparatus of claim 38, wherein the means for determining the CSI is configured to independently estimate channel quality of each channel of a plurality of channels based on the descrambled reference signal, each channel comprising a link between a cell of the plurality of cells and the apparatus.

44. A computer-program product for wireless communications, comprising a computer-readable medium comprising instructions executable to:
receive, at a user equipment (UE), a reference signal transmitted from each of a plurality of cells in a cluster at one or more common time-frequency resources, wherein the cells in the cluster cooperate to transmit data to a set of UE devices including the UE;
determine channel state information (CSI) based on the reference signal; and
transmit the CSI to the cells in the cluster.

45. The computer-program product of claim 44, wherein the time-frequency resources are based on a cluster identifier (ID) identifying the cluster.

46. The computer-program product of claim 44, wherein determining the CSI comprises directly estimating channel quality of a combined channel, the combined channel comprising channels between the plurality of cells and the UE.

47. The computer-program product of claim 44, wherein determining the CSI comprises independently estimating channel quality of each channel of a plurality of channels based on the reference signal, each channel comprising a link between a cell of the plurality of cells and the UE.
